(19) United States
(12) Patent Application Publication
(10) Pub. No.: US 2024/0400918 A1
(43) Pub. Date: Dec. 5, 2024

(54) Method of Reducing Impurities in Pyrolysis Oil

(71) Applicants: SK Innovation Co., Ltd., Seoul (KR); SK Geo Centric Co., Ltd., Seoul (KR)

(72) Inventors: Sang Hwan Jo, Daejeon (KR); Soo Kil Kang, Daejeon (KR); Ho Won Lee, Daejeon (KR); Yong Seong Jeong, Daejeon (KR); Se Rah Moon, Daejeon (KR)

(21) Appl. No.: 18/409,257

(22) Filed: Jan. 10, 2024

(30) Foreign Application Priority Data
Jun. 2, 2023 (KR) 10-2023-0071419

(51) Int. Cl. C10G 67/02; C10B 53/07

(52) U.S. Cl. CPC C10G 67/02; C10B 53/07; C10G 2300/1003; C10G 2300/202

(57) ABSTRACT

The present disclosure relates to a method of refining waste plastic pyrolysis oil, the method including the steps of: S1) pyrolyzing waste plastics to produce pyrolysis oil; S2) separating monomers from a depolymerization product recovered by depolymerizing polyethylene terephthalate (PET) with alcohol and adding a remaining depolymerization residue to the pyrolysis oil; S3) mixing the depolymerization residue with the pyrolysis oil to produce refined pyrolysis oil; and S4) separating the refined pyrolysis oil and the depolymerization residue. The refined pyrolysis oil may have a reduced content of impurities, such as nitrogen. Also provided is a method of removing nitrogen in pyrolysis oil by mixing, with pyrolysis oil, a residue generated during a recycling process of polyethylene terephthalate (PET), which should be disposed of as waste, and exhibits an effect of significantly reducing a content of nitrogen in pyrolysis oil.

### CROSS-REFERENCE TO RELATED APPLICATION

This application claims priority to Korean Patent Application No. 10-2023-0071419, filed Jun. 2, 2023, the disclosure of which is hereby incorporated by reference in its entirety.

### BACKGROUND OF THE INVENTION

### Field of the Invention

The following disclosure relates to a method of producing pyrolysis oil having a reduced content of impurities.

### DESCRIPTION OF THE INVENTION

Waste plastics, which are produced using petroleum as a feedstock, are difficult to recycle and are mostly disposed of as garbage. These wastes take a long time to degrade in nature, which causes contamination of the soil and serious environmental pollution. As plastic decomposes by exposure to sunlight and heat, the plastic waste releases greenhouse gases such as methane and ethylene. Incineration of plastic waste releases significant amounts of greenhouse gases (GHG), such as carbon dioxide, nitrous oxide and/or methane, into the environment. Carbon dioxide is the primary greenhouse gas contributing to climate change.

As a method for recycling waste plastics, there is a method for pyrolyzing waste plastics and converting the pyrolyzed waste plastics into usable oil, and the obtained oil is called waste plastic pyrolysis oil.

However, pyrolysis oil obtained by pyrolyzing waste plastics cannot be used directly as a high-value-added fuel such as gasoline or diesel oil because it has a higher content of impurities, such as chlorine, nitrogen, and metals, than oil produced from crude oil through a common process. In particular, when a nitrogen component remains in the oil, a subsequent catalyst process may be adversely affected, and thus, the nitrogen component should be controlled below a certain level.

In the related art, nitrogen has been removed during a pyrolysis process by a method of removing nitrogen in advance by performing a process such as sorting or washing waste plastics, or a method of performing pyrolysis by additionally adding water or a strong base material during pyrolysis. However, an additional process for sorting or washing is required, internal corrosion of a reactor occurs, or environmental pollution is caused due to waste water and off-gas. Accordingly, the development of economical processes that may reduce impurities in pyrolysis oil has been studied in many ways.

Meanwhile, polyethylene terephthalate (PET) is easily molded due to its large crystallinity and high melting point, and thus PET is widely used not only in fibers but also in films, bottles, and injection-type materials. In particular, PET is used in a container such as a bottle due to excellent mechanical properties including lightness, durability, and high transparency, and chemical properties such as gas permeability, chemical resistance, and high-quality content maintenance, and a large amount of PET is discharged as waste. There are two main ways to recycle PET discharged as waste: physical recycling and chemical recycling. Physical recycling involves using PET in the form of polyester clips or flakes, and chemical recycling is performed by recovering a polyester feedstock using a chemical reaction. Among them, methanolysis is a method of decomposing PET to recover ethylene glycol (EG) and dimethyl terephthalate (DMT). The recovered EG and DMT may be recycled by being reused in a PET synthesis polymerization process. A recovery rate of EG and DMT recovered by the methanolysis reaction is about 90%, and in this case, about 10% of a residue is generated. The methanolysis residue of PET is in the form in which unrecovered EG and DMT, a catalyst, a salt, and the like are unevenly mixed in a high-viscosity liquid, and this residue cannot be reused and is disposed of as waste. As a method for disposing of the residue, landfilling and the like are used, but this not only incurs additional processing costs, but also causes environmental pollution caused by landfilling the residue. However, methanolysis of PET is actively used commercially because DMT may be obtained with high purity in comparison to other PET chemical recycling methods and DMT is easy to recycle as a feedstock. Accordingly, there is a need to develop an effective processing method for a residue generated by methanolysis of PET.

### RELATED ART DOCUMENT

### Patent Document

Japanese Patent Laid-Open Publication No. 2003-034794 (Feb. 7, 2003)

### SUMMARY OF THE INVENTION

In some embodiments, the present disclosure is directed to providing a method of refining waste plastic pyrolysis oil that may utilize a depolymerization residue of PET, which is waste, as a useful resource, and at the same time, may effectively reduce a content of impurities, such as nitrogen, in pyrolysis oil produced by pyrolysis of waste plastics.

In some embodiments, the present disclosure is directed to providing a method of refining waste plastic pyrolysis oil that has excellent efficiency in removing impurities, such as nitrogen, in pyrolysis oil and also has process stability to continuously remove impurities such as chlorine, oxygen, and metals.

In some embodiments, a method of refining waste plastic pyrolysis oil comprises the steps of: S1) pyrolyzing waste plastics to produce pyrolysis oil; S2) separating monomers from a depolymerization product recovered by depolymerizing polyethylene terephthalate (PET) with alcohol and adding a remaining depolymerization residue to the pyrolysis oil; S3) mixing the depolymerization residue with the pyrolysis oil to produce refined pyrolysis oil; and S4) separating the refined pyrolysis oil and the depolymerization residue.

In some embodiments, the step S4) may comprise: separating the refined pyrolysis oil and the depolymerization residue into two phases; and removing the depolymerization residue located in a lower layer.

In some embodiments, a mixing temperature in the step S3) may be 50° C. to 100° C.

In some embodiments, the alcohol may be methanol and/or ethanol.

In some embodiments, the depolymerization residue may comprise sulfate.

In some embodiments, the depolymerization residue may comprise ethylene glycol.

In some embodiments, the depolymerization residue may comprise alkyl terephthalate.

In some embodiments, the ethylene glycol may be comprised in an amount of 10 to 85 wt % with respect to the total weight of the depolymerization residue.

In some embodiments, the sulfate may be comprised in the depolymerization residue in an amount of 1 to 30 wt %.

In some embodiments, the sulfate may comprise an alkali metal sulfate and/or an alkaline earth metal sulfate.

In some embodiments, in the step S2), the depolymerization residue may be added to the pyrolysis oil in an amount of 50 to 150 parts by weight with respect to 100 parts by weight of the pyrolysis oil.

In some embodiments, a temperature of the pyrolysis may be 400° C. to 600° C.

In some embodiments, the method may further comprise, after the step S4), hydrotreating the refined pyrolysis oil.

In some embodiments, the refined pyrolysis oil may have less impurities, such as less nitrogen, than the waste plastic pyrolysis oil.

In some embodiments, a method is provided for removing nitrogen from pyrolysis oil, the method comprising the steps of: S1) pyrolyzing waste plastics to produce pyrolysis oil; S2) separating monomers from a depolymerization product recovered by depolymerizing polyethylene terephthalate (PET) with alcohol and adding a remaining depolymerization residue to the pyrolysis oil; S3) mixing the depolymerization residue with the pyrolysis oil to produce refined pyrolysis oil; and S4) separating the refined pyrolysis oil and the depolymerization residue.

Other features and aspects will be apparent from the following detailed description, the drawings, and the claims.

### BRIEF DESCRIPTION OF THE DRAWINGS

FIG. 1 is a schematic view illustrating a method of refining and/or reducing impurities in waste plastic pyrolysis oil according to an exemplary embodiment of the present disclosure.

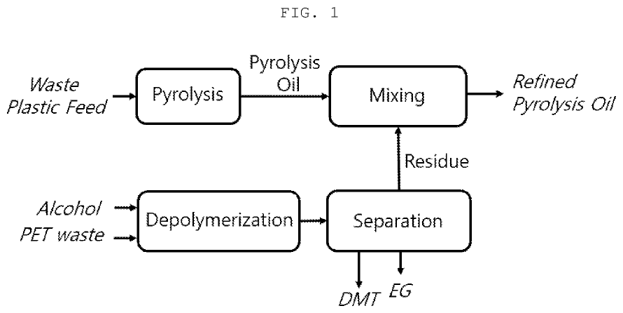

### DESCRIPTION OF THE INVENTION

Unless otherwise defined, all of the technical terms and scientific terms used in the present specification have the same meanings as commonly understood by those skilled in the art to which the present disclosure pertains.

Unless the context clearly indicates otherwise, the singular forms of the terms used in the present specification may be interpreted as including the plural forms. As used herein, the singular form of “a”, “an”, and “the” include plural referents unless the context clearly states otherwise.

For the purposes of this specification, unless otherwise indicated, all numbers expressing quantities of ingredients, reaction conditions, dimensions, physical characteristics, and so forth used in the specification and claims are to be understood as being modified in all instances by the term “about.” Unless indicated to the contrary, the numerical parameters set forth in the following specification and attached claims are approximations that can vary depending upon the desired properties sought to be obtained by the present invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

A numerical range used in the present specification includes upper and lower limits and all values within these limits, all double limited values, and all possible combinations of the upper and lower limits in the numerical range defined in different forms. Unless otherwise specifically defined in the present specification, values out of the numerical range that may occur due to experimental errors or rounded values also fall within the defined numerical range. For example, a range of “1 to 10” is intended to include any and all sub-ranges between and including the recited minimum value of 1 and the recited maximum value of 10, that is, all subranges beginning with a minimum value equal to or greater than 1 and ending with a maximum value equal to or less than 10, and all subranges in between, e.g., 1 to 6.3, or 5.5 to 10, or 2.7 to 6.1.

The expression “comprise(s)” described in the present specification is intended to be an open-ended transitional phrase having an equivalent meaning to “include(s)”, “contain(s)”, “have (has)”, or “are (is) characterized by”, and does not exclude elements, materials, or steps, all of which are not further recited herein.

Unless otherwise defined, a unit of “%” used in the present specification refers to “wt %”.

Unless otherwise defined, impurities mentioned in the present specification comprise nitrogen impurities, chlorine impurities, oxygen impurities, sulfur impurities and/or metals.

Pyrolysis oil obtained by pyrolyzing waste plastics cannot be used directly as a high-value-added fuel such as gasoline or diesel oil because it has a higher content of impurities such as chlorine, nitrogen, and metals than oil produced from crude oil through a common process. In particular, when a nitrogen component remains in the oil, a subsequent catalyst process may be adversely affected, and thus, the nitrogen component should be controlled below a certain level.

In the related art, impurities contained in waste plastics to be used as a pyrolysis oil feedstock are removed using a sorting or washing process. However, as environmental pollution is caused by waste water and off-gas generated at this time, and an additional process such as sorting or washing waste plastics is required before the pyrolysis process, the process becomes complex and costs increase. Meanwhile, alcohol depolymerization is widely used to recycle PET, one of the most used waste plastics, but in this case, a PET depolymerization residue is generated and should be disposed of as waste.

Accordingly, the inventors of the present disclosure have found that nitrogen, one of impurities in pyrolysis oil, could be significantly reduced by adding a depolymerization residue generated during alcohol depolymerization of waste polyethylene terephthalate (PET) to an impurity removal process of waste plastic pyrolysis oil, according to the present disclosure.

In some embodiments, the present disclosure provides a method of refining waste plastic pyrolysis oil, the method comprising: S1) pyrolyzing waste plastics to produce pyrolysis oil; S2) separating monomers from a depolymerization product recovered by depolymerizing polyethylene terephthalate (PET) with alcohol and adding a remaining depolymerization residue to the pyrolysis oil; S3) mixing the depolymerization residue with the pyrolysis oil to produce refined pyrolysis oil; and S4) separating the refined pyrolysis oil and the depolymerization residue. In some embodiments, the refined pyrolysis oil may have less impurities, such as less nitrogen, than the waste plastic pyrolysis oil.

PET is one of the most widely used plastics in various industrial fields due to its high strength and lightness. Alcohol depolymerization, one of the methods to recycle PET, is a method of depolymerizing PET using alcohol under a temperature condition of 50° C. to 300° C. in a pressure range of 1 atm to 50 atm. In particular, the alcohol depolymerization is one of the most widely used recycling methods because it has an advantage of being used to recycle PET present in solid waste. PET polymerizable monomers such as ethylene glycol and alkyl terephthalate produced by alcohol depolymerization of waste PET are separated, recovered, and reused as a feedstock for PET polymerization. Ethylene glycol, dimethyl terephthalate, and dimethyl terephthalate-like materials that are not separated, a catalyst, and various salts are disposed of as alcohol depolymerization residues. In some embodiments, the methods of the present disclosure may exhibit an effect of significantly reducing a content of nitrogen in pyrolysis oil and improving waste recycling and economic efficiency of a pyrolysis oil production process by mixing these alcohol depolymerization residues of PET, otherwise to be disposed of as waste, with waste plastic pyrolysis oil and using the mixture to produce refined pyrolysis oil which may have a reduced content of nitrogen compared to the waste plastic pyrolysis oil.

In some embodiments, the step S1) is a step of pyrolyzing waste plastics to produce pyrolysis oil.

In some embodiments, the waste plastics may be domestic waste plastic and/or industrial waste plastic. The domestic waste plastic may be a polyolefin-based waste plastic, or may be a plastic in which PVC, PS, PET, PBT, and/or the like in addition to PE and/or PP are mixed.

In some embodiments, the pyrolysis reaction may be performed in a batch reactor. In some embodiments, the pyrolysis reaction may be performed in any reactor capable of controlling stirring and temperature increase, and for example, the pyrolysis may be performed in a rotary kiln type batch reactor, but the present disclosure is not limited thereto.

In some embodiments, a temperature of the pyrolysis may be 450° C. to 580° C., or 480° C. to 550° C.

In some embodiments, the pyrolysis reaction may be performed in a non-oxidizing atmosphere. The non-oxidizing atmosphere is an atmosphere in which waste plastics do not oxidize (combust), and efficient pyrolysis may be performed in the above atmosphere. In some embodiments, the non-oxidizing atmosphere is, for example, an atmosphere in which an oxygen concentration is adjusted to 1 vol % or less, and/or may be an atmosphere of an inert gas such as nitrogen, water vapor, carbon dioxide, or argon. In some embodiments, the pyrolysis process may be stably performed in a low-oxygen atmosphere in which an oxygen concentration is adjusted to 1 vol % or less. In some embodiments, the pyrolysis reaction may be performed in a non-oxidizing atmosphere for 150 minutes to 350 minutes, and when the above holding time is satisfied, the non-oxidizing atmosphere may be activated, the pyrolysis may be sufficiently performed, and energy consumption and operating time may be minimized, which is preferable. In some embodiments, the holding time may be 170 minutes to 330 minutes, or 200 minutes to 300 minutes.

In some embodiments, the step S2) is a step of separating monomers from a depolymerization product recovered by depolymerizing polyethylene terephthalate (PET) with alcohol and adding a remaining depolymerization residue to the pyrolysis oil produced in the step S1).

In some embodiments, the depolymerization residue of PET may be obtained in a process of depolymerizing PET with alcohol to obtain a depolymerization product and then separating monomers from the depolymerization product. In some embodiments, it is possible to obtain a depolymerization residue generated in a process of evaporating alcohol, which is included in excess, from a mixed solution comprising ethylene glycol and alkyl terephthalate produced by depolymerization of PET and then separating ethylene glycol and alkyl terephthalate. In this case, ethylene glycol and alkyl terephthalate are separated through a separation column, and the separated ethylene glycol has sufficient purity to be used as a polymerizable monomer for PET, but alkyl terephthalate needs to go through a recrystallization process because it requires higher purity in order to be reused as a feedstock of PET, and a residue of the PET depolymerization may be obtained by recovering a solution released during recrystallization. The depolymerization residue obtained by the above method may be added to the pyrolysis oil obtained in the step S1).

In some embodiments, a temperature of the depolymerization may be 20° C. to 400° C., or 50° C. to 300° C., a pressure of the PET depolymerization may be 1 atm to 70 atm, or 1 atm to 50 atm, and a depolymerization time between PET and alcohol may be 1 to 24 hours, or 1 to 12 hours.

In some embodiments, as a catalyst for the depolymerization, a metal salt such as sodium, calcium zinc, magnesium, and/or cobalt salt may be used, but any catalyst that may allow PET and alcohol to react with each other to depolymerize PET and alcohol into equivalents of ethylene glycol and alkyl terephthalate may be used without limitation.

In some embodiments, the alcohol used in the depolymerization may be an aliphatic alcohol, for example, methanol and/or ethanol, or methanol.

In some embodiments, the alcohol that reacts with PET in the depolymerization may be comprised in an amount of 150 to 1,000 parts by weight, or 200 to 800 parts by weight, with respect to 100 parts by weight of PET. In order to increase reaction efficiency, the depolymerization is performed by adding alcohol in excess of the amount of PET. In some embodiments, the alcohol added in excess may be discharged as during the vapor depolymerization and may be recycled as a PET depolymerization reactant.

In some embodiments, the residue of the PET depolymerization may comprise not only ethylene glycol and alkyl terephthalate that are not separated, but also materials such as alkyl isophthalate, a catalyst, a salt, and chlorine. Since the above materials are unevenly mixed in a high-viscosity liquid, these materials cannot be reused and are generally disposed of as waste, but when the depolymerization residue is used as an additive in the pyrolysis process of waste plastics, it is highly effective in reducing impurities, in particular, nitrogen, in pyrolysis oil.

Alkyl terephthalate and alkyl isophthalate may vary depending on the type of alcohol used in the depolymerization of PET. In some embodiments, an alkyl group of alkyl terephthalate or alkyl isophthalate may be a C1-C8 linear or branched alkyl group, or a C1-C4 linear or branched alkyl group. In some embodiments, when methanol is used as the alcohol in the depolymerization of PET, alkyl terephthalate and alkyl isophthalate may be dimethyl terephthalate and dimethyl isophthalate, respectively.

In some embodiments, the salt may comprise sulfate, and for example the sulfate may be an alkali metal sulfate and/or an alkaline earth metal sulfate, but the present disclosure is not limited thereto.

In some embodiments, the ethylene glycol may be comprised in a lower limit of 10 wt % or more, 20 wt % or more, or 30 wt % or more, and an upper limit of 90 wt % or less or 85 wt % or less, with respect to the total weight of the depolymerization residue, and may be comprised in an amount of, for example, 10 to 90 wt %, or 10 to 85 wt %, with respect to the total weight of the depolymerization residue.

In some embodiments, the alkyl terephthalate may be comprised in a lower limit of 5 wt % or more, 10 wt % or more, or 15 wt % or more, and an upper limit of 50 wt % or less, 40 wt % or less, or 35 wt % or less, with respect to the total weight of the depolymerization residue, and may be comprised in an amount of 5 to 40 wt %, or 5 to 35 wt %, with respect to the total weight of the depolymerization residue.

In some embodiments, the salt may be comprised in an amount of 10 to 50 wt %, or 10 to 40 wt %, with respect to the total weight of the depolymerization residue, and the sulfate may be comprised in a lower limit of 1 wt % or more, 2 wt % or more, or 5 wt % or more, and an upper limit of 30 wt % or less or 20 wt % or less, with respect to the total weight of the depolymerization residue, and may be comprised in an amount of 1 to 30 wt %, or 1 to 15 wt %, with respect to the total weight of the depolymerization residue.

As the ethylene glycol, alkyl terephthalate, and sulfate are comprised in the depolymerization residue in the contents described above, nitrogen in the pyrolysis oil may be effectively removed. In the related art, nitrogen contained in the pyrolysis oil has been removed by adding and mixing water or a strong base material to the pyrolysis oil. However, since water is already contained in the pyrolysis oil, not only is the nitrogen reduction effect reduced, but the added water should be removed again in a subsequent process, and a method of adding a strong base material causes corrosion problems in the reactor and generates new waste water. On the other hand, the present disclosure exhibits a remarkable effect of removing 70% or more, 75% or more, 80% or more, 85% or more, 90% or more, 95% or more, or 99% or more, of nitrogen compared to the initial content of nitrogen in the pyrolysis oil through a simple process of mixing the pyrolysis oil with the depolymerization residue of PET.

In the step S2), the depolymerization residue may be added in a lower limit of 30 parts by weight or more, 60 parts by weight or more, or 70 parts by weight or more, and an upper limit of 250 parts by weight or less, 200 parts by weight or less, or 150 parts by weight or less, with respect to 100 parts by weight of the pyrolysis oil, and may be added in an amount of 50 to 150 parts by weight, or 70 to 130 parts by weight, with respect to 100 parts by weight of the pyrolysis oil.

As the depolymerization residue is added to the pyrolysis oil in the range described above in the step S2), stirring removal of nitrogen contained in the pyrolysis oil may be effectively achieved with high efficiency.

The step S3) is a step of mixing the depolymerization residue with the waste plastic pyrolysis oil to produce refined pyrolysis oil from which nitrogen is removed. A method of mixing the depolymerization residue with the waste plastic pyrolysis oil is not limited to stirring, shaking, or mixing, and specifically, may be stirring.

In some embodiments, a lower limit of a mixing temperature may be 30° C. or higher, 40° C. or higher, or 50° C. or higher, an upper limit of the mixing temperature may be 150° C. or lower, 130° C. or lower, or 100° C. or lower, and the mixing temperature may be 30 to 150° C., or 50 to 100° C. Since waste plastic pyrolysis oil has a high viscosity at room temperature, material exchange between the pyrolysis oil and the depolymerization residue may be facilitated in the above temperature range, and impurities contained in the pyrolysis oil may be effectively extracted into the depolymerization residue.

In some embodiments, a lower limit of a mixing time may be 50 minutes or longer, 70 minutes or longer, or 100 minutes or longer, an upper limit of the mixing time may be 500 minutes or shorter, 400 minutes or shorter, or 300 minutes or shorter, and the mixing time may be 50 to 300 minutes, or 100 to 250 minutes, but is not limited thereto.

In some embodiments, the method of mixing the depolymerization residue with the pyrolysis oil is stirring, a stirring speed may be 50 to 5,000 rpm, or 100 to 4,000 rpm. The stirring speed may be appropriately changed at a level that allows the depolymerization residue to be easily mixed with the waste plastic pyrolysis oil, but is not limited thereto.

The step S4) is a step of phase-separating the mixed depolymerization residue and pyrolysis oil and removing the depolymerization residue to recover refined pyrolysis oil.

In some embodiments, the step S4) may comprise: separating the refined pyrolysis oil and the depolymerization residue into two phases; and removing the depolymerization residue located in a lower layer.

In the step S4), the mixture of the pyrolysis oil and the depolymerization residue may be phase-separated into refined pyrolysis oil from which nitrogen is removed and a depolymerization residue as the mixture is allowed to stand for a certain period of time. In some embodiments, the standing time may be 0.3 to 12 hours, or 1 to 10 hours.

In some embodiments, a method of removing the depolymerization residue from the phase-separated refined pyrolysis oil and depolymerization residue may be performed by a method of discharging the phase-separated depolymerization residue through an outlet located at the bottom of the reactor to obtain refined pyrolysis oil, but is not limited as long as it is a known reaction capable of removing a phase-separated layer.

In some embodiments, a method is provided for removing nitrogen from pyrolysis oil, the method comprising the steps of: S1) pyrolyzing waste plastics to produce pyrolysis oil; S2) separating monomers from a depolymerization product recovered by depolymerizing polyethylene terephthalate (PET) with alcohol and adding a remaining depolymerization residue to the pyrolysis oil; S3) mixing the depolymerization residue with the pyrolysis oil to produce refined pyrolysis oil; and S4) separating the refined pyrolysis oil and the depolymerization residue.

The present disclosure exhibits an effect of enabling easy separation into refined pyrolysis oil compared to a known technique of removing impurities using a mixture of water or a strong basic aqueous solution and pyrolysis to oil remove nitrogen. Specifically, in the related art, there is a problem that water or a strong basic aqueous solution forms an emulsion with pyrolysis oil, and it takes a long time to separate layers, or complete separation does not occur even when the solution is allowed to stand for a long time. On the other hand, the depolymerization residue is better phase-separated from the pyrolysis oil than water or the strong basic aqueous solution, and as a result, it is easy to obtain refined pyrolysis oil.

In some embodiments, the present disclosure may further comprise hydrotreating the refined pyrolysis oil separated in the step S4). The hydrotreating step is a step of allowing the refined pyrolysis oil to react with hydrogen gas to remove impurities. The refined pyrolysis oil is additionally dechlorinated, denitrified, and demetallized by the hydrotreating reaction, such that impurities such as chlorine, nitrogen, and metals and some olefins may be removed. As the hydrotreating step is further comprised in the present disclosure, it is possible to produce high-quality pyrolysis oil in which a content of other impurities such as chlorine and metals as well as the content of nitrogen is significantly reduced.

In some embodiments, a temperature in the hydrotreating step may be 300 to 500° C., or 350 to 420° C., or 370 to 400° C. When the hydrotreating is performed in the temperature range described above, impurities comprising nitrogen may be further removed, and a content of moisture in the refined pyrolysis oil may be minimized to prevent corrosion and catalyst deactivation during the process. In the temperature range described above, moisture in the waste plastic pyrolysis oil may be effectively removed, and thus, corrosion and catalyst deactivation may be suppressed, and phenomena such as coking due to thermal cracking may be suppressed.

In some embodiments, a pressure in the hydrotreating step may be more than 60 bar and less than 120 bar, or 65 bar to 110 bar, or 70 bar to 100 bar. In the pressure range described above, impurities comprising chlorine and nitrogen may be effectively removed, and formation of an ammonium salt (NH₄Cl) may be suppressed.

In some embodiments, the hydrotreating step may be performed using an active metal as a catalyst, and the type of the catalyst is not limited. In some embodiments, only an active metal may be comprised as a catalyst, or a catalyst supported on a support may be used. The active metal may comprise one or two or more selected from molybdenum, nickel, cobalt, and/or tungsten.

### Example 1

Domestic waste plastic pellets were prepared by extruding domestic mixed plastics including polyethylene, polypropylene, and polyvinyl chloride at 250° C. Pyrolysis was performed by adding about 70 g dry weight of the domestic waste plastic pellets to a batch reactor and increasing the temperature of the reactor to 500° C. in a non-oxidizing atmosphere. After the pyrolysis was completed, pyrolysis oil was recovered.

Waste PET was added to a reactor into which an alkali metal salt catalyst was introduced in the form of a PET oligomer sludge, and the temperature was increased to 270° C. Separately, a temperature of a methanol liquid was increased to 270° C. at a rate of 20 cc/min and injected into the reactor. When a liquid level in the reaction device was reduced as the reaction proceeded, this state was detected by a sensor, and an oligomer sludge feedstock melted to 200° C. was injected from a feedstock tank into the reactor to replenish the feedstock.

A reaction product was separated through the top together with methanol and transferred to a separation and refining unit, the transferred product and methanol were cooled, and DMT was recrystallized, thereby obtaining solid DMT and a PET depolymerization residue. In the depolymerization residue, 60 wt % of ethylene glycol, 15 wt % of dimethyl terephthalate and a derivative thereof, and 25 wt % of the balance including the catalyst, salt, and methanol, were included.

10 g of the recovered pyrolysis oil was added to a first reactor, 7 g of the PET depolymerization residue was added to the pyrolysis oil in the first reactor to produce mixed oil, and a temperature of the mixed oil was increased to 80° C., and mixing was performed at a stirring speed of 300 rpm for 180 minutes. After the stirring was completed, the mixture was allowed to stand for 3 hours while maintaining the temperature. Thereafter, only the depolymerization residue separated into layers at a lower part of the mixed oil was separated and discharged through an outlet located at the bottom of the reactor, thereby obtaining refined waste plastic pyrolysis oil. The content of nitrogen in the refined pyrolysis oil is shown in Table 1.

### Example 2

The same process as that of Example 1 was performed, except that 10 g of the PET depolymerization residue was added.

### Example 3

The same process as that of Example 1 was performed, except that 13 g of the PET depolymerization residue was added.

### Example 4

The same process as that of Example 1 was performed, except that 15 g of the PET depolymerization residue was added.

### Example 5

The same process as that of Example 1 was performed, except that stirring was performed at room temperature without increasing the temperature of the mixed oil.

### Comparative Example 1

Domestic waste plastic pellets were prepared by extruding domestic mixed plastics including polyethylene, polypropylene, and polyvinyl chloride at 250° C. Pyrolysis was performed by adding about 70 g dry weight of the domestic waste plastic pellets to a batch reactor and increasing the temperature of the reactor to 500° C. in a non-oxidizing atmosphere. After the pyrolysis was completed, pyrolysis oil was recovered. The content of nitrogen contained in 10 g of the recovered pyrolysis oil is shown in Table 1.

### Comparative Example 2

The same process as that of Example 1 was performed, except that 10 g of water was added instead of 10 g of the PET depolymerization residue.

### Comparative Example 3

The same process as that of Example 1 was performed, except that 10 g of an aqueous NaOH solution was added instead of 10 g of the PET depolymerization residue.

TABLE 1

| | | | | | | Comparative | Comparative | Comparative |
|---|---|---|---|---|---|---|---|---|
| | Example 1 | Example 2 | Example 3 | Example 4 | Example 5 | Example 1 | Example 2 | Example 3 |
| Amount of | 10 | 10 | 10 | 10 | 10 | 10 | 10 | 10 |
| pyrolysis oil | | | | | | | | |
| addled (g) | | | | | | | | |
| Additive | PET | PET | PET | PET | PET | — | Water | Aqueous NaOH |
| | depolymer- | depolymer- | depolymer- | depolymer- | depolymer- | | | solution |
| | ization | ization | ization | ization | ization | | | |
| | residue | residue | residue | residue | residue | | | |
| Amount of | 7 | 10 | 13 | 15 | 10 | — | 10 | 10 |
| additive added | | | | | | | | |
| (g) | | | | | | | | |
| Stirring | 80 | 80 | 80 | 25 | 25 | — | 80 | 80 |
| temperature (° C.) | | | | | | | | |
| Stirring time | 180 | 180 | 180 | 180 | 180 | — | 180 | 180 |
| (min) | | | | | | | | |
| Nitrogen in | 1,089 | 1,007 | 941 | 894 | 1,524 | 3,690 | 2,503 | 1,656 |
| pyrolysis oil | | | | | | | | |
| (ppm) | | | | | | | | |
| Sulfur in | 32 | 28 | 23 | 21 | 27 | 54 | 43 | 34 |
| pyrolysis oil | | | | | | | | |
| (ppm) | | | | | | | | |

Referring to Table 1, it could be appreciated that the nitrogen reduction effect was significantly increased when the PET depolymerization residue was used as an additive compared to when water or NaOH was used as an additive. Specifically, when the PET depolymerization residue was used as an additive and mixed with pyrolysis oil, the nitrogen removal rate increased as the content of the PET depolymerization residue increased, and the maximum nitrogen removal rate was 75%. However, it was confirmed that when water or an aqueous NaOH solution was used, the nitrogen removal rate was only 55% at maximum.

In addition, when water or NaOH was used, the standing time was longer than when the PET depolymerization residue was used, and an emulsion was partially formed between the pyrolysis oil and the water or NaOH layer. On the other hand, in the step of removing nitrogen in the pyrolysis oil by mixing the pyrolysis oil and the additive and then separating and recovering the additive and the pyrolysis oil, when the pyrolysis oil and the PET depolymerization residue were allowed to stand after stirring, layer separation was easily performed, and as a result, the pyrolysis oil was easily recovered.

As set forth above, in the method of reducing impurities in waste plastic pyrolysis oil according to the present disclosure, the methanolysis depolymerization residue of PET is used, such that the content of nitrogen in pyrolysis oil may be effectively reduced.

In the method of reducing impurities in waste plastic pyrolysis oil according to the present disclosure, as nitrogen contained in pyrolysis oil is effectively removed, formation of an ammonium salt (NH₄Cl) is suppressed or minimized in the hydrotreating process, such that the refining process may be stably performed for a long period of time.

Hereinabove, although the present disclosure has been described by specific matters and limited exemplary embodiments, they have been provided only for assisting in the entire understanding of the present disclosure. Therefore, the present disclosure is not limited to the exemplary embodiments. Various modifications and changes may be made by those skilled in the art to which the present disclosure pertains from this description.

Therefore, the spirit of the present disclosure should not be limited to these exemplary embodiments, but the claims and all modifications equal or equivalent to the claims are intended to fall within the scope and spirit of the present disclosure.

What is claimed is:

1. A method for refining waste plastic pyrolysis oil, the method comprising the steps of:
S1) pyrolyzing waste plastics to produce pyrolysis oil;
S2) separating monomers from a depolymerization product recovered by depolymerizing polyethylene terephthalate (PET) with alcohol and adding a remaining depolymerization residue to the pyrolysis oil;
S3) mixing the depolymerization residue with the pyrolysis oil to produce refined pyrolysis oil; and
S4) separating the refined pyrolysis oil and the depolymerization residue.

2. The method of claim 1, wherein step S4) comprises:
separating the refined pyrolysis oil and the depolymerization residue into two phases; and
removing the depolymerization residue located in a lower layer.

3. The method of claim 1, wherein a mixing temperature in step S3) is 50° C. to 100° C.

4. The method of claim 1, wherein the alcohol is methanol and/or ethanol.

5. The method of claim 1, wherein the depolymerization residue comprises sulfate.

6. The method of claim 1, wherein the depolymerization residue comprises ethylene glycol.

7. The method of claim 1, wherein the depolymerization residue comprises alkyl terephthalate.

8. The method of claim 6, wherein the ethylene glycol is comprised in an amount of 10 to 85 wt % with respect to the total weight of the depolymerization residue.

9. The method of claim 5, wherein the sulfate is comprised in the depolymerization residue in an amount of 1 to 30 wt %.

10. The method of claim 5, wherein the sulfate comprises an alkali metal sulfate and/or an alkaline earth metal sulfate.

11. The method of claim 1, wherein in step S2), the depolymerization residue is added to the pyrolysis oil in an amount of 50 to 150 parts by weight with respect to 100 parts by weight of the pyrolysis oil.

12. The method of claim 1, wherein a temperature of the pyrolysis is 400° C. to 600° C.

13. The method of claim 1, further comprising, after step S4), hydrotreating the refined pyrolysis oil.

14. The method of claim 1, wherein the refined pyrolysis oil has less nitrogen than the waste plastic pyrolysis oil.

15. A method for removing nitrogen from pyrolysis oil, the method comprising the steps of:
S1) pyrolyzing waste plastics to produce pyrolysis oil;
S2) separating monomers from a depolymerization product recovered by depolymerizing polyethylene terephthalate (PET) with alcohol and adding a remaining depolymerization residue to the pyrolysis oil;
S3) mixing the depolymerization residue with the pyrolysis oil to produce refined pyrolysis oil; and
S4) separating the refined pyrolysis oil and the depolymerization residue.
